(19) United States
(12) Patent Application Publication
(10) Pub. No.: US 2012/0224619 A1
(43) Pub. Date: Sep. 6, 2012

(54) WIRELESS RECEIVER DEVICE AND DIRECTIVITY CONTROL METHOD

(75) Inventor: Atsuhiko Hashigaya, Kanagawa (JP)

(73) Assignee: PANSONIC CORPORTION, Osaka (JP)

(21) Appl. No.: 13/508,976

(22) PCT Filed: Feb. 17, 2011
(86) PCT No.: PCT/JP2011/000889

§ 371 Date: May 9, 2012

(30) Foreign Application Priority Data
Feb. 26, 2010 (JP) 2010-042446

(51) Int. Cl. H04W 40/20; H04W 40/12; H04W 24/00

(52) U.S. Cl. 375/224

(57) ABSTRACT

Disclosed is a radio reception apparatus that can prevent deterioration of reception quality, even when a delayed wave having a delay exceeding the length of a guard interval is present in the SFN environment. In this apparatus, OFDM receiver (100) receives a radio signal via a network using a single frequency. Antenna directivity control section (122) forms directivity that is used when receiving a signal. OFDM reception section (120) measures a reception level and reception quality. Transmission station information database (140) stores positional information of a transmission station by associating the information with the transmission station. Determination section (121) selects a transmission station based on the reception level, the reception quality, current positional information of OFDM receiver (100), and the positional information of the transmission station stored in transmission station information database (140), and changes the directivity to be formed by antenna directivity control section (122) per selection.

### TECHNICAL FIELD

The present invention relates to a radio reception apparatus and a directivity control method. For example, the present invention relates to a radio reception apparatus for receiving an OFDM signal in the network using a single frequency, such as the single frequency network (SFN) and a directivity control method in that apparatus.

### BACKGROUND ART

Conventionally, for example, in the system in which an orthogonal frequency division multiplexing (OFDM) signal is transmitted and received, such as digital terrestrial broadcasting, a technique for duplicating part of a signal in the tail section per symbol period of an OFDM signal to be transmitted and received, and adding the duplicated part to the head section of the same symbol period, has been used. The part duplicated in this way is called a guard interval. By adding a guard interval, even when a delayed wave that is delayed within a certain time, such as a reflected wave, is received, the delayed wave does not become an interference wave, so that it is possible to perform stable demodulation processing.

Further, in recent years, multi-media broadcasting for next generation mobile phones that employs the integrated services digital broadcasting terrestrial mobile multi-media broadcasting (ISDB-Tmm) scheme, which is an evolved version of the integrated services digital broadcasting for terrestrial (ISDB-T) scheme, has been proposed. The ISBD-Tram scheme uses the SFN system using a single frequency (for example, see Patent Literature 1). In particular, for the ISDB-Tmm, a service in the VHF band is under consideration, in which a radio wave propagates better than a radio wave of digital television broadcasting in the UHF band.

### CITATION LIST

### Patent Literature

PTL 1.
International Publication No. 2008/047441

### SUMMARY OF INVENTION

### Technical Problem

However, conventionally, when performing communication using a channel in which a delay having the length of a guard interval or longer occurs, or when performing communication in the network environment, such as the SFN, in which a delayed wave having a delay exceeding the length of a guard interval is likely to be received, there is a problem that interference occurs. As a result of this, a problem of deterioration of reception quality arises.

It is therefore an object of the present invention to provide a radio reception apparatus and a directivity control method for making it possible to prevent deterioration of reception quality, even when a delayed wave having a delay exceeding the length of a guard interval is present in the SFN environment.

### Solution to Problem

A radio reception apparatus according to the present invention employs a configuration to include a radio reception apparatus that receives a radio signal via a network using a single frequency, the apparatus including: a reception section that receives a radio signal; a directivity formation section that forms directivity that is used when receiving the radio signal by the reception section; a measurement section that measures a reception level and reception quality of the radio signal received by the reception section; a storage section that stores a communicating party and positional information of the communicating party by associating the communicating party with the positional information; and a determination section that selects the communicating party based on the reception level, the reception quality, current positional information, and the positional information of the communicating party stored in the storage section, and changes the directivity to be formed by the directivity formation section, per selection.

A directivity control method according to the present invention employs a configuration to include a directivity control method that receives a radio signal via a network using a single frequency, the method including steps of: receiving a radio signal; forming directivity that is used when receiving the radio signal; measuring a reception level and reception quality of the received radio signal; storing a communicating party and positional information of the communicating party by associating the communicating party with the positional information; and selecting the communicating party based on the reception level, the reception quality, current positional information of the radio reception apparatus, and the stored positional information of the communicating party, and changing the directivity per selection.

### Advantageous Effects of Invention

According to the present invention, even when a delayed wave having a delay exceeding the length of a guard interval is present in the SFN environment, it is possible to prevent deterioration of reception quality.

### BRIEF DESCRIPTION OF DRAWINGS

FIG. 1 is a block diagram showing a configuration of an OFDM receiver according to Embodiment 1 of the present invention;

FIG. 2 is a flow chart showing an operation of antenna directivity control of an OFDM receiver according to Embodiment 1 of the present invention;

FIG. 3 is a flow chart showing an operation of antenna directivity control of an OFDM receiver according to Embodiment 2 of the present invention;

FIG. 4 shows positions of an OFDM receiver, transmission station A, and transmission station B according to Embodiment 2 of the present invention;

FIG. 5 is a flow chart showing an operation of antenna directivity control of an OFDM receiver according to Embodiment 3 of the present invention; and

FIG. 6 shows positions of an OFDM receiver, transmission station k, and transmission station A according to Embodiment 3 of the present invention.

### DESCRIPTION OF EMBODIMENTS

(Explanation of Principle)

A fundamental concept of the present invention will be described below,

N antennas (here, N≧2) are prepared, First, antennas are combined using N arbitrary antennas.

When the reception level after synthesis is a predetermined level or greater and reception quality deteriorates to lower than a predetermined level, antenna directivity is changed by controlling the signal phase and the synthesis ratio of antenna output.

The above-described algorithm for controlling antenna directivity selects an SFN transmission station depending on the distance from an OFDM receiver, and controls antenna directivity so as to receive a signal from the selected transmission station the best.

When, from a viewpoint of an OFDM receiver, a delayed wave having a delay exceeding the length of a guard interval is transmitted from a transmission station in a totally different direction from the dominant wave, it is possible to increase the difference of level between the dominant wave and the delayed wave by performing control so as to receive the dominant wave the strongest.

When a delayed wave having a delay exceeding the length of a guard interval causes deterioration of reception quality, it is the case where the level of the delayed wave is close to the level of the dominant wave, so that it is possible to improve reception quality by making the difference of level between the dominant wave and the delayed wave greater. If, from the viewpoint of the OFDM receiver, a delayed wave having a delay exceeding the length of the guard interval is transmitted from the transmission station located in the same direction as the dominant wave, antenna directivity is controlled to receive a signal from a transmission station located in a different direction from the transmission station from which the OFDM receiver is receiving the dominant wave. By this means, it is possible to change the time difference and the level difference between a delayed wave and a transmission wave that the OFDM receiver is going to receive from the transmission station, making it possible to improve reception quality.

Now, embodiments of the present invention will be described in detail with reference to the accompanying drawings. A case will be described with the following embodiments as examples where an OFDM receiver is used as a radio reception apparatus.

### Embodiment 1

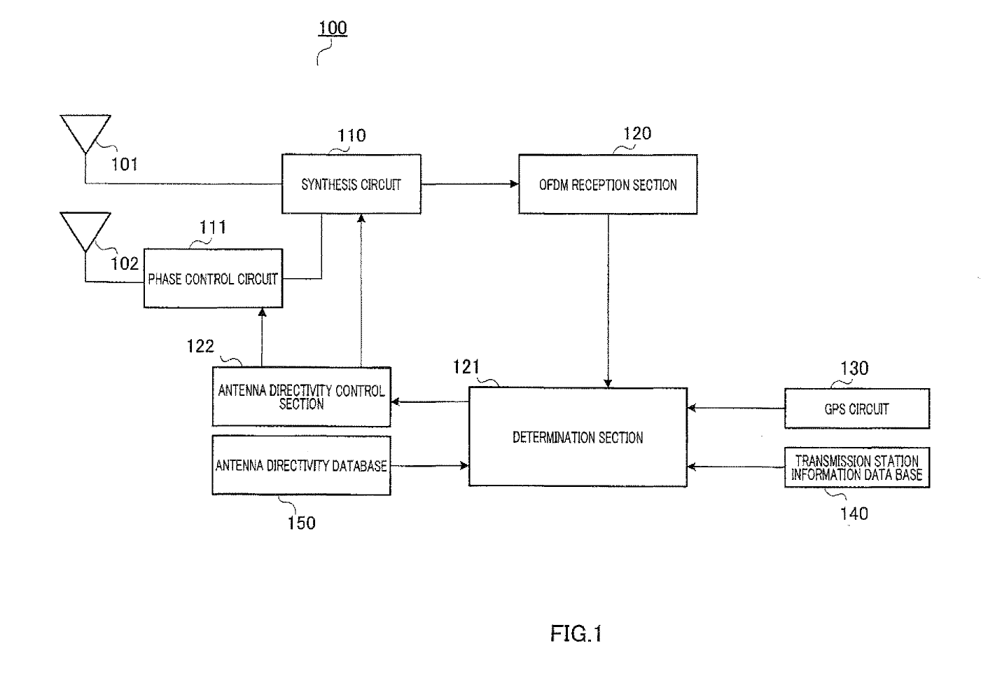

FIG. 1 is a block diagram showing a configuration of OFDM receiver 100, which is a radio reception apparatus according to the present embodiment based on the above-described fundamental concept. OFDM receiver 100 according to the present embodiment is applied to a mobile receiver of a mobile phone, for example.

As shown in FIG. 1, OFDM receiver 100 is configured to include two antennas 101 and 102, synthesis circuit 110, phase control circuit 111, OFDM reception section 120, determination section 121, antenna directivity control, section 122, GPS circuit 130, transmission station information database 140, and antenna directivity database 150.

Antenna 101 receives a radio signal and outputs the signal to synthesis circuit 110.

Antenna 102 receives a radio signal and outputs the signal to phase control circuit 111.

Synthesis circuit 110 switches the synthesis ratio of the reception signal input from antenna 101 to the reception signal input from antenna 102, according to the signal input from antenna directivity control section 122. Further, synthesis circuit 110 synthesizes reception signals with a predetermined ratio, and outputs the synthesis signal to OFDM reception section 120.

Phase control circuit 111 switches the phase of the reception signal input from antenna 102 according to the signal input from antenna directivity control section 122, and output the obtained signal to synthesis circuit 110,

OFDM reception section 120 performs, for example, amplification, selection, and demodulation on the synthesis signal input from synthesis circuit 110, and outputs the obtained signal to determination section 121, as a reception signal. Further, OFDM reception section 120 measures the reception level and reception quality of the synthesis signal input from synthesis circuit 110, and outputs the result of the measurement to determination section 121. Indexes to indicate reception quality include the bit error rate (BER) or the carrier to noise ratio (CNR).

Determination section 121 is configured with, for example, CPU, a program memory, or a working memory, and controls antenna directivity control section 122, Further, when configuring determination section 121 with, for example, a micro processor, it is possible to configure determination section 121 with, for example, the CPU that is provided as the main function of a reception terminal apparatus (not shown) equipped with OFDM receiver 100.

Determination section 121 controls antenna directivity based on the measurement result of the reception level and the reception quality input from OFDM reception section 120. Specifically, determination section 121 selects the transmission station from which OFDM receiver 100 will receive the dominant wave, based on the positional information of OFDM receiver 100 obtained from GPS circuit 130 and the positional information of the transmission station obtained from transmission station information database 140. Further, determination section 121 calculates the direction of the selected transmission station to determine the direction in which the maximum directivity of the antenna can be obtained. Further, determination section 121 obtains information about directivity for forming directivity in the determined maximum directivity direction, from antenna directivity database 150. Then, determination section 121 outputs the obtained information about directivity to antenna directivity control section 122, as a control signal.

Antenna directivity control section 122 forms directivity that is used when receiving a signal, Specifically, antenna directivity control section 122 outputs the signal for controlling the synthesis ratio based on the control signal input from determination section 121, to synthesis circuit 110, and outputs the signal for controlling switch of the phase, to phase control circuit 111.

Transmission station information database 140 stores information about, for example, the position of the transmission station by associating that information with the transmission station.

Antenna directivity database 150 stores information about directivity combined and formed by antenna 101 and antenna 102.

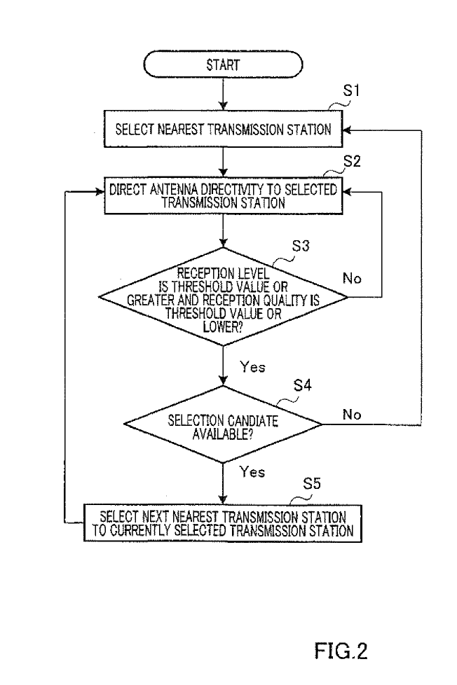

Next, an operation of antenna directivity control of OFDM receiver 100 as configured above will be described with reference to FIG. 2.

FIG. 2 is a flow chart showing an operation of antenna directivity control of OFDM receiver 100, and the operation is repeated at a predetermined timing by determination section 121. In FIG. 2, “S” represents each step in the flow.

First, determination section 121 selects the nearest transmission station to the current position of OFDM receiver 100, based on the information obtained from GPS circuit 130 and transmission station information database 140 (step S1).

Next, determination section 121 calculates the direction of the selected transmission station, sends the order to match the calculated direction with the maximum directivity direction of the antenna, to antenna directivity control secton 122, and controls phase control circuit 111 and synthesis circuit 110 (step S2).

Next, determination section 121 determines whether or not reception quality is poor (step S3). Specifically, when the reception level measured by OFDM reception section 120 is a predetermined threshold value or greater and the reception quality measured by OFDM reception section 120 is a predetermined threshold value or lower (step S3: Yes), determination section 121 determines that a delayed wave having a delay exceeding the length of the guard interval is present. In this case, determination section 121 determines that the reception quality is poor and shifts the processing to step S4.

On the other hand, when the reception level measured by OFDM reception section 120 is the predetermined value or greater, and the reception quality measured by OFDM reception section 120 is not the predetermined shreshold value or lower (step S3: No), determination section 121 determines that the reception quality is not poor, and continues reception at step S2.

Further, upon determining that the reception quality is poor (step S3: Yes), determination section 121 determines whether or not other transmission stations are present around OFDM receiver 100, based on the information obtained from transmission station information database 140 (step S4).

Upon determining that other base stations are present (step S4: Yes), determination section 121 selectes the next nearest transmission station to the currently selected transmission station (step S5).

On the other hand, upon determining that other base stations are not present (step S4: No), determination section 121 repeats the processing of step S1 to step 53.

As described above, according to the present embodiment, when the reception level is a predetermined level or greater and reception quality is a predetermined level or lower, an OFDM receiver controls the maximum directivity direction of the antenna so as to be directed to the next nearest transmission station to the currently selected transmission station.

That is, an OFDM receiver controls antenna directivity so as not to receive a signal from the transmission station that is generating a delayed wave having a delay exceeding the length of the guard interval. By this means, it is possible to improve reception sensitivity, so that, even when a delayed wave having a delay exceeding the length of the guard interval is present in the SFN environment, it is possible to prevent deterioration of reception quality.

### Embodiment 2

A case will be described with the present embodiment where, as an antenna directivity control algorithm, when a delayed wave having a delay exceeding the length of the guard interval arrives from the direction of the nearest transmission station to a receiver, antenna directivity is controlled so as not to receive this delayed wave.

Because the configuration of an OFDM receiver according to the present embodiment is the same as OFDM receiver 100 of FIG. 1, overlapping explanations will be omitted and the OFDM receiver according to the present embodiment will be described assigning the same reference numerals as in FIG. 1.

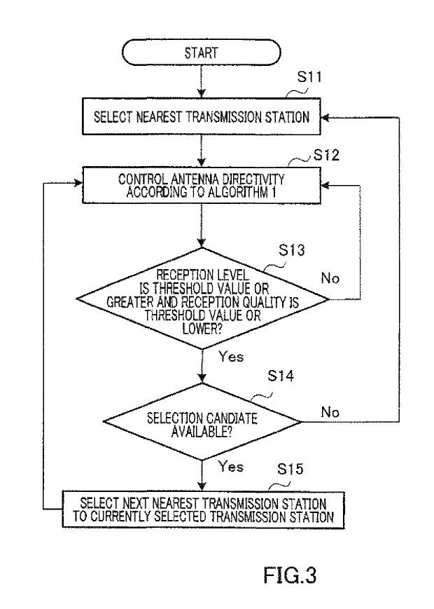

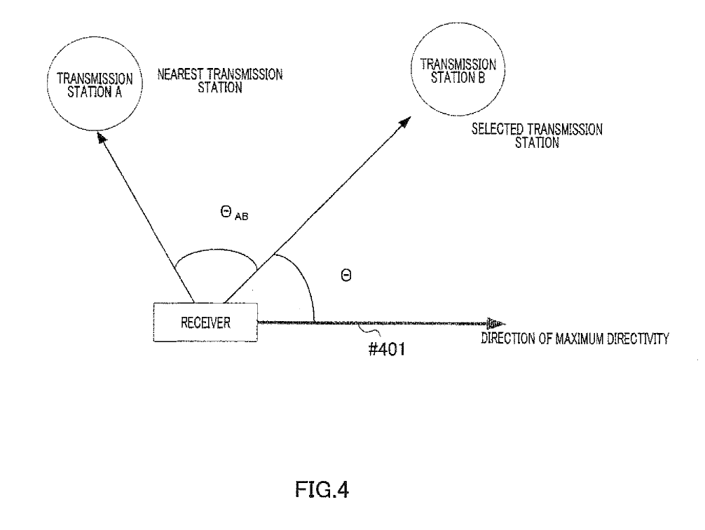

FIG. 3 is a flow chart showing an operation of antenna directivity control of an OFDM receiver, which is a radio reception apparatus according to the present embodiment, and the operation is repeated at a predetermined timing by determination section 121. In FIG. 3, “S” represents each step in the flow. FIG. 4 shows positions of OFDM receiver 100, transmission station A, and transmission station B. In FIG. 4, transmission station A is the nearest transmission station to OFDM receiver 100, and transmission station B is the transmission station selected by OFDM receiver 100.

In FIG. 3, the difference from above-described Embodiment 1 is mainly an antenna directivity control method in step S12.

First, determination section 121 selects transmission station B from the current position of OFDM reciver 100, based on the information obtained from OPS circuit 130 and transmission station information database 140 (step S11). Specifically, determination section 121 selects a transmission station sequentially in order from the next nearest transmission station B other than the nearest transmission station A that is currently selected.

Then, determination section 121 controls antenna directivity so as not to receive a delayed wave from the nearest station A (step S12).

Specifically, determination section 121 determines antenna directivity according to the following algorithm. That is, determination section 121 estimates the reception level of selected transmission station B by equation 1, based on the information obtained from antenna directivity database 150 and the positional information of selected transmission station B that is obtained from transmission station information database 140.

[1]

C(θ)=G(θ)×R_{B} (Equation 1)
Here, G(θ): Antenna directivity
   θ: Angle from the maximum directivity of the antenna
   R_{B}: Reception level estimated from the distance between OFDM receiver 100 and transmission station B
   B: Selected transmission station

Next, determination section 121 estimates the reception level of transmission station A by equation 2, based on the information obtained from antenna directivity database 150 and the positional information of the nearest transmission station A that is obtained from transmission station information database 140.

[2]

1(θ)=G(θ+θ_{AB})×R_{A} (Equation 2)
Here, θ_{AB}: Angle formed with transmission station A and transmission station B from the viewpoint of OFDM receiver 100
   R_{A}: Reception level estimated from the distance between OFDM receiver 100 and transmission station A
   A: Nearest transmission station
   B: Selected transmission station

Next, determination section 121 determines θ to maximize C(θ)/I(θ), and performs control so as to form antenna directivity in the direction of θ to maximize C(θ)/I(θ). Then, antenna directivity control section 122 forms antenna directivity in the direction of θ to maximize C(θ)/I(θ) (in the direction of arrow #401 of FIG. 4).

Here, when transmission station A=transmission station B is satisified, determination section 121 determines θ=0. That is, when the nearest transmission station A to OFDM receiver 100 is selected, determination section 121 performs control so as to direct antenna directivity in the direction of transmission station A.

With reference to FIG. 3 again, after step S12, determination section 121 determines whether or not the reception quality is poor (step S13). Specifically, when the reception level measured in OFDM reception section 120 is the predetermined threshold value or greater and the reception quality measured by OFDM reception section 120 is the predetermined threshold value or lower (step S13: Yes), determination section 121 determines that a delayed wave having a delay exceeding the length of the guard interval is present. In this case, determination section 121 determines that the reception quality is poor and shifts the processing to step S14.

On the other hand, when the reception level measured by OFDM reception section 120 is the predetermined value or greater and the reception quality measured by OFDM reception section 120 is not the predetermined shreshold value or lower (step S13: No), determination section 121 determines that the reception quality is not poor, and continues reception at step S12.

Further, upon determining that the reception quality is poor (step S13: Yes), determination section 121 determines whether or not other transmission stations are present around OFDM receiver 100, based on the information obtained from transmission station information database 140 (step S14).

Upon determining that other base stations are present (step S14: Yes), determination section 121 selectes the next nearest transmission station to the currently selected transmission station (step S15).

On the other hand, upon determining that other base stations are not present (step S14: No), determination section 121 repeats the processing of step S11 to step S13.

As described above, according to the present embodiment, in the case where the maximum directivity of the antenna is directed to the nearest transmission station A to the OFDM receiver, when the reception quality is poor, it is expected that a delayed wave having a delay exceeding the length of the guard interval is arriving from other transmission station in the same direction of the nearest transmission station A, from the viewpoint of the OFDM receiver. Therefore, an OFDM receiver controls antenna directivity so that the difference between the reception level of a delayed wave and the reception level of the dominant wave is maximized. By this means, according to the present embodiment, when a delayed wave having a delay exceeding the length of the guard interval is arriving from other transmission station in the same direction as the nearest transmission station A from the viewpoint of an OFDM receiver, it is possible to improve reception sensitivity. As a result of this, even when a delayed wave having a delay exceeding the length of the guard interval is present in the SFN environment, it is possible to prevent deterioration of reception quality.

### Embodiment 3

A case will be described with the present embodiment where, as an antenna directivity control algorithm, a transmission station from which a delayed wave having a delay exceeding the length of a guard interval can be transmitted is extracted out of the transmission stations selected based on positional information of transmission stations, and antenna directivity is controlled so as not to receive a radio wave from the extracted transmission station,

Because the configuration of an OFDM receiver according to the present embodiment is the same as OFDM receiver 100 of FIG. 1, overlapping explanations will be omitted and the OFDM receiver according to the present embodiment will be described assigning the same reference numerals as in FIG. 1.

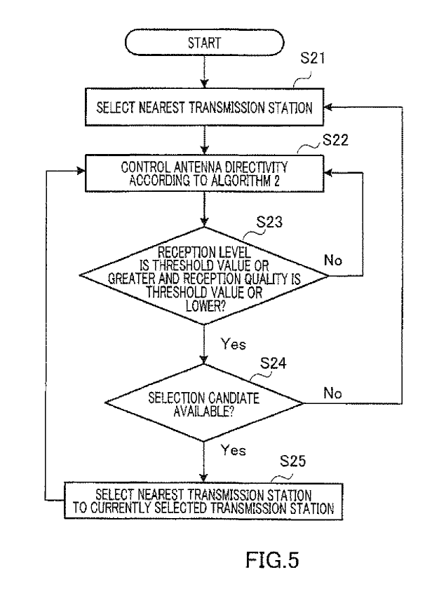

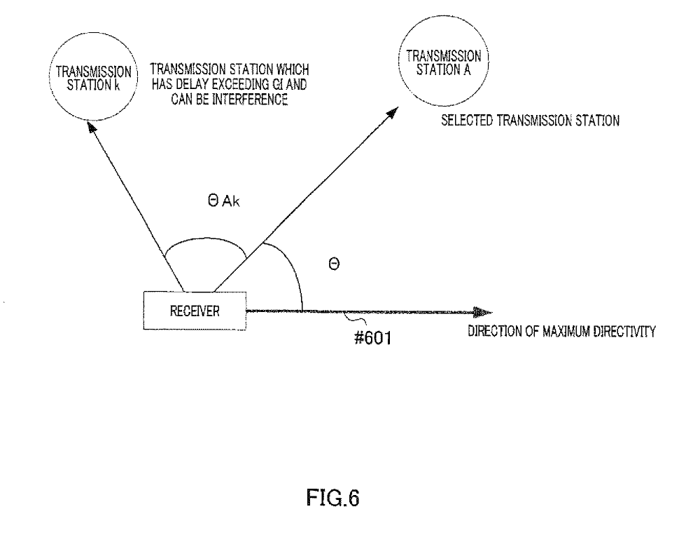

FIG. 5 is a flow chart showing an operation of antenna directivity control of an OFDM receiver, which is a radio reception apparatus according to the present embodiment, and the operation is repeated at a predetermined timing by determination section 121. Further, in FIG. 5 “S” refers to each step in the flow. FIG. 6 shows positions of OFDM receiver 100, transmission station k, and transmission station A. In FIG. 6, transmission station k is a transmission station that can be interference with OFDM receiver 100, and transmission station A is the transmission station selected by OFDM receiver 100.

In FIG. 5, the difference from above-described Embodiment 1 is mainly an antenna directivity control method in step S22.

First, determination section 121 selects transmission station A, from the current position of OFDM receiver 100, based on the information obtained from GPS circuit 130 and transmission station information database 140 (step S21).

Next, determination section 121 controls antenna directivity so as not to receive a radio wave from transmission station k that can be a delayed wave having a delay exceeding the length of the guard interval (step S22).

Specifically, determination section 121 determines antenna direcitvity according to the following algorithm,

That is, determination section 121 estimates the reception level of selected transmission station A by equation 3, based on the information obtained from antenna directivity database 150 and the positional information of selected transmission station A that is obtained from transmission station information database 140.

[3]

C(θ)=G(θ)×R_{A} (Equation 3)
Here, G(θ): Antenna directivity
   θ: Angle from the maximum directivity of the antenna
   R_{A}: Reception level estimated from the distance between OFDM receiver 100 and transmission station A
   A: Selected transmission station

Next, determination section 121 extracts transmission station k from which a delayed wave having a delay exceeding the length of the guard interval can be transmitted, based on the distance between selected transmission A and OFDM receiver 100. Specifically, because an interference wave is a delayed wave, determination section 121 can determine delayed time based on the distance between transmission station A and OFDM receiver 100, and determination section 121 determines whether or not the determined delay time exceeds the length of the guard interval. By this means, determination section 121 extracts transmission station k having a delayed time determined by the above-described method exceeds the length of the guard interval. Further, in the above-described case, determination section 121 can extract a plurality of transmission stations. Then, determination section 121 estimates the reception level of transmission station k by equation 4, based on the information obtained from antenna directivity database 150 and the positional information of transmission station k that is obtained from transmission station information database 140.

[4]

Iₖ(θ)=G(θ+θ_{Ak})×Rₖ (Equation 4)
Here, θ_{Ak}: Angle formed with transmission station A and transmission station B from the viewpoint of OFDM receiver 100
   R_{K}: Reception level estimated from the distance between OFDM receiver 100 and transmission station k
   A: Selected transmission station
   K: Transmission station from which a delayed wave having a delay exceeding the length of the guard interval arrives at OFDM receiver 100

Next, determination section 121 determines θ to maximize C(θ)/ΣIₖ(θ), and performs control so as to form antenna directivity in the direction of θ to maximize C(θ)/ΣIₖ(θ). Then, antenna directivity control section 122 forms antenna directivity in the direction of θ to maximize C(θ)/ΣIₖ(θ) (in the direction of arrow #601 of FIG. 6).

With reference to FIG. 5 again, after step S22, determination section 121 determines whether or not the reception quality is poor (step S23). Specifically, when the reception level measured by OFDM reception section 120 is the predetermined threshold value or greater and the reception quality measured by OFDM reception section 120 is the predetermined threshold value or lower (step S23: Yes), determination section 121 determines that a delayed wave having a delay exceeding the length of the guard interval is present. In this case, determination section 121 determines that the reception quality is poor, and shifts the processing to step S24.

On the other hand, when the reception level measured by OFDM reception section 120 is the predetermined value or greater, and the reception quality measured by OFDM reception section 120 is not the predetermined shreshold value or lower (step S23: No), determination section 121 determines that the reception quality is not poor, and continues reception at step S22.

Further, upon determining that the reception quality is poor (step S23: Yes), determination section 121 determines whether or not other transmission stations are present around OFDM receiver 100, based on the information obtained from transmission station information database 140 (step S24).

Upon determining that other base stations are present (step S24: Yes), determination section 121 selectes the next nearest transmission station to the currently selected transmission station (step S25).

On the other hand, upon determining that other transmission stations are not present (step S24: No), determination section 121 repeats the processing of step S21 to step S23.

As described above, according to the present embodiment, by controlling antenna directivity so as to maximize the difference between the reception level of a delayed wave and the reception level of the dominant wave, an OFDM receiver can improve reception sensitivity. As a result of this, even when a delayed wave having a delay exceeding the length of the guard interval is present in the SFN environment, it is possible to prevent deterioration of reception quality.

Above-described Embodiment 1 to Embodiment 3 are examples of preferable embodiments of the present invention, and the scope of the present invention is not limited to these.

For example, although cases have been described with the above embodiments where two antennas are used, the present invention is not limited to this, and the number of antennas is not limited and it is possible to use three antennas or more. Further, even when three antennas or more are used, it is possible to achieve the same effects as the effects achieved when two antennas are used.

Further, although cases have been described with the above embodiments where directivity is controlled by antenna synthesis, the present invention is not limited to this, and it is equally possible to control directivity by moving one antenna mechanically.

Further, in the above-described embodiments, the type, the number, and the connecting method of each circuit section forming an OFDM receiver are not limited to the type, the number, and the connecting method indicated by the above-described embodiments.

The disclosure of Japanese Patent Application No. 2010-42446, filed on Feb. 26, 2010, including the specification, drawings and abstract, is incorporated herein by reference in its entirety.

### INDUSTRIAL APPLICABILITY

A radio reception apparatus and a directivity control method according to the present invention are suitable for receiving an OFDM signal in the network using a single frequency, for example.

### REFERENCE SIGNS LIST

100 OFDM receiver
101, 102 Antenna
110 Synthesis circuit
111 Phase control circuit
120 OFDM reception section
121 Determination section
122 Antenna directivity control section
130 GPS circuit
140 Transmission station information database
150 Antenna directivity database

1-6. (canceled)

7. A radio reception apparatus that receives a radio signal via a network using a single frequency, the apparatus comprising:
a reception section that receives a radio signal;
a directivity formation section that forms directivity that is used when receiving the radio signal by the reception section;
a measurement section that measures a reception level and reception quality of the radio signal received by the reception section;
a storage section that stores a communicating party and positional information of the communicating party by associating the communicating party with the positional information; and
a determination section that selects the communicating party based on the reception level, the reception quality, current positional information, and the positional information of the communicating party stored in the storage section, and changes the directivity to be formed by the directivity formation section, per selection;
wherein, when the reception level is a first threshold value or greater and the reception quality is a second threshold value or lower, the determination section selects the nearest communicating party based on the current positional information and the positional information of the communicating party that is stored in the storage section, and changes the directivity to be formed by the directivity formation section to a directivity directed toward the selected nearest communicating party.

8. The radio reception apparatus according to claim 7, wherein, in the case where the directivity is formed toward the nearest communicating party by the directivity formation section, when the reception level is the first threshold value or greater and the reception quality is the second threshold value or lower, the determination section selects the communicating party sequentially in order from the nearer communicating party other than the nearest communicating party, based on the current positional information and the positional information of the communicating party stored in the storage section, and sequentially changes the directivity to be formed by the directivity formation section to the directivity directed toward the selected communicating party, so that the reception quality becomes greater than the second threshold value.

9. The radio reception apparatus according to claim 7, wherein, in the case where the directivity is formed toward the nearest communicating party by the directivity formation section, when the reception level is the first threshold value or greater and the reception quality is the second threshold value or lower, the determination section selects the communicating party sequentially in order from the nearer communicating party other than the nearest communicating party, based on the current positional information and the positional information of the communicating party stored in the storage section, and sequentially changes the directivity to be formed by the directivity formation section to the directivity directed toward an angle to maximize a divided value determined by dividing a value determined by following equation 5 by a value determined by following equation 6, so that the reception quality becomes greater than the second threshold value:
[5]
C(θ)=G(θ)×R_{B} (Equation 5)
Here, G(θ): Antenna directivity
θ: Angle from the maximum directivity of the antenna
R_{B}: Reception level estimated from a distance between the radio reception apparatus and communicating party (B)
B: Selected communicating party
[6]
I(θ)=G(θ+θ_{AB})×R_{A} (Equation 6)
Here, θ_{AB}: Angle formed with first communicating party (A) and second communicating party (B) from the viewpoint of the radio reception apparatus
R_{A}: Reception level estimated from a distance between the radio reception apparatus and communicating party (A)
A: Nearest communicating party
B: Selected communicating party

10. The radio reception apparatus according to claim 7, receiving a radio signal via the network using a single frequency, the apparatus comprising:
the reception section that receives a radio signal;
the directivity formation section that forms directivity that is used when receiving the radio signal by the reception section;
the measurement section that measures the reception level and the reception quality of the radio signal received by the reception section;
the storage section that stores the communicating party and the positional information of the communicating party by associating the communicating party with the positional information; and
the determination section that selects the communicating party based on the reception level, the reception quality, the current positional information, and the positional information of the communicating party stored in the storage section, and changes the directivity to be formed by the directivity formation section, per selection;
wherein the determination section selects the communicating party sequentially in order from the nearer communicating party based on the current positional information and the positional information of the communicating party stored in the storage section, and sequentially changes the directivity to be formed by the directivity formation section to a directivity directed toward an angle to maximize a divided value determined by deviding a value determined by following equation 7 by a value determined by following equation 8, so that the reception quality becomes greater than the threshold value:
[7]
C(θ)=G(θ)×R_{A} (Equation 7)
Here, G(θ): Antenna directivity
θ: Angle from the maximum directivity of the antenna
R_{A}: Reception level estimated from a distance between the radio reception apparatus and communicating party (A)
A: Selected communicating party
[8]
ΣIₖ(θ)=Σ(G(θ+θ_{Ak})×Rₖ) (Equation 8)
Here, θ_{Ak}: Angle formed with first communicating party (A) and second communicating party (k) from the viewpoint of the radio reception apparatus
R_{K}: Reception level estimated from a distance between the radio reception apparatus and communicating party (k)
A: Selected communicating party
k: Communicating party from which a delayed wave having a delay exceeding the length of a guard interval arrives at the radio reception apparatus

11. A directivity control method in a radio reception apparatus that receives a radio signal via a network using a single frequency, the method comprising:
a reception step of receiving a radio signal;
a directivity formation step of forming directivity that is used when receiving the radio signal;
a measurement step of measuring a reception level and reception quality of the received radio signal;
a storage step of storing a communicating party and positional information of the communicating party by associating the communicating party with the positional information; and
a determination step of selecting the communicating party based on the reception level, the reception quality, current positional information of the radio reception apparatus, and the stored positional information of the communicating party, and changing the directivity per selection;
wherein, when the reception level is a first threshold value or greater and the reception quality is a second threshold value or lower, the determination step selects the nearest communicating party based on the current positional information and the positional information of the communicating party that is stored by the storage step, and changes the directivity to be formed by the directivity formation step to the directivity directed toward the selected nearest communicating part.
